(19) United States
(12) Patent Application Publication
(10) Pub. No.: US 2026/0164508 A1
(43) Pub. Date: Jun. 11, 2026

(54) INDUCTION HEATER CONTROL FOR A COOKTOP

(71) Applicant: WHIRLPOOL CORPORATION, BENTON HARBOR, MI (US)

(72) Inventors: Mario Barbati, Comerio (IT); Andrea Gallivanoni, Casorate Sempione (IT); Salvatore Baldo, Varese (IT); Paolo Sanfelice, Varese (IT)

(73) Assignee: WHIRLPOOL CORPORATION, BENTON HARBOR, MI (US)

(21) Appl. No.: 18/971,825

(22) Filed: Dec. 6, 2024

(51) Int. Cl. H05B 1/02; H05B 6/06

(52) U.S. Cl. CPC H05B 1/0266; H05B 6/065

(57) ABSTRACT

An induction cooktop includes a first coil, a second coil, switching circuitry including a first full-bridge inverter that drives the first coil, a second full-bridge inverter that drives the second coil, and a shared half-bridge inverter common to the first full-bridge inverter and the second full-bridge inverter, and control circuitry configured to operate the switching circuitry at a common switching frequency to generate different power levels among the first coil and the second coil.

### BACKGROUND OF THE DISCLOSURE

The present disclosure relates to induction heater control for a cooktop and, more specifically, to systems and methods for controlling full-bridge inverters for induction heaters of a cooktop.

### SUMMARY OF THE DISCLOSURE

According to one aspect of the present disclosure, an induction cooktop includes a first coil, a second coil, switching circuitry including a first full-bridge inverter that drives the first coil, a second full-bridge inverter that drives the second coil, and a shared half-bridge inverter common to the first full-bridge inverter and the second full-bridge inverter, and control circuitry configured to operate the switching circuitry at a common switching frequency to generate different power levels among the first coil and the second coil.

According to another aspect, a heating circuit includes a first coil, a second coil, switching circuitry including a first full-bridge inverter that drives the first coil, a second full-bridge inverter that drives the second coil, and a shared half-bridge inverter common to the first full-bridge inverter and the second full-bridge inverter, and control circuitry configured to operate the switching circuitry at a common switching frequency, and adjust a phase of activation signals to the switching circuitry at the common switching frequency by a phase shift to generate different power levels among the first coil and the second coil.

According to yet another aspect, an induction cooktop includes a first coil, a second coil, switching circuitry including a first full-bridge inverter that drives the first coil, a second full-bridge inverter that drives the second coil, and a shared half-bridge inverter common to the first full-bridge inverter and the second full-bridge inverter, wherein each full-bridge inverter includes a secondary half-bridge inverter that forms a full-bridge inverter with the shared half-bridge inverter, and wherein each of the secondary half-bridge inverters includes a pair of switches operated at the common switching frequency, and control circuitry configured to operate the switching circuitry at a common switching frequency, and adjust a phase of activation signals to the switches at the common switching frequency by a phase shift to generate a first power level for the first coil and a second power level different than the first power level for the second coil.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top perspective view of an induction cooktop;

FIG. 2 is an electrical schematic of a heating circuit for an induction cooktop;

FIG. 3 is a first timing plot of activation signals and power output of a coil for an induction cooktop operated with a full-bridge inverter operated with no phase shift;

FIG. 4 is a second timing plot of activation signals and power output of a coil for an induction cooktop operated with a full-bridge inverter operated with a phase shift of 90°;

FIG. 5 is a plot of power vs. phase shift for a given switching frequency;

FIG. 6A is a plot demonstrating a relationship between power and phase shift for different common switching frequencies for a first resonant circuit operated at twelve different frequencies;

FIG. 6B is a plot demonstrating a relationship between power and frequency for different phase shifts for the first resonant circuit operated at five different phase shifts;

FIG. 7A is a plot demonstrating a relationship between power and phase shift for different common switching frequencies for a second resonant circuit operated at twelve different frequencies;

FIG. 7B is a plot demonstrating a relationship between power and frequency for different phase shifts for the second resonant circuit operated at five different phase shifts;

FIG. 8 is a flow diagram of a method for controlling switching circuitry of heating circuit for an induction cooktop;

FIG. 9A is functional block diagram of at least a portion of a step of the method of FIG. 8;

FIG. 9B is detailed flow diagram of at least a portion of a step of the method of FIG. 8;

FIG. 9C is detailed flow diagram of at least a portion of a step of the method of FIG. 8;

FIG. 9D is detailed flow diagram of at least a portion of a step of the method of FIG. 8;

FIG. 10 is a plot demonstrating two articles of cookware having different power-frequency curves;

FIG. 11 is a plot of current and voltage for two coils operated with activation signals communicated at a common switching frequency with different phase shifts to achieve first target power levels; and

FIG. 12 is a plot of current and voltage for two coils operated with activation signals communicated at a common switching frequency with different phase shifts to achieve second target power levels.

The components in the figures are not necessarily to scale, emphasis instead being placed upon illustrating the principles described herein.

### DETAILED DESCRIPTION

The present illustrated embodiments reside primarily in combinations of method steps and apparatus components related to an induction heater control for a cooktop 10. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

In general, the present disclosure provides for a control algorithm that employs phase shifting and generates a common operational frequency for some or all of the heater coils of an appliance. The control algorithm allows for an arrangement of circuitry that can have a reduced number of switching devices for controlling the heater coils. Further, the present circuit and control algorithm can limit noise (e.g., clicking sounds) from the circuit by limiting fully-on/off combinations of the switching devices. In this way, the circuit can provide for fine-tuned power modulation for the circuit.

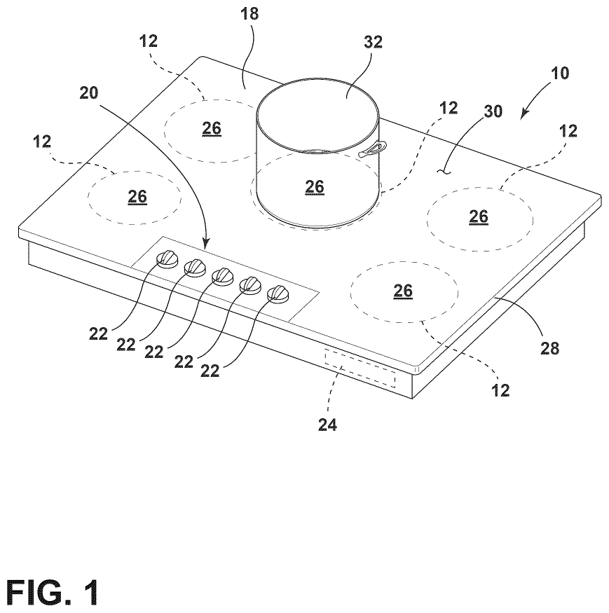

Referring generally to FIGS. 1-12, numeral 10 generally designates an induction cooktop 10. The induction cooktop 10 includes a first coil 12a and a second coil 12b. Switching circuitry 13 includes a first full-bridge inverter that drives the first coil 12a, a second full-bridge inverter that drives the second coil 12b, and a shared half-bridge inverter 14 common to the first full-bridge inverter and the second full-bridge inverter. The induction cooktop 10 includes control circuitry configured to operate the switching circuitry 13 at a common switching frequency to generate different power levels among the first coil 12a and the second coil 12b.

Referring now to FIG. 1, the induction cooktop 10 may include a cooking area 18 and a control interface 20 which may include knobs 22 and/or touch interfaces for controlling the induction cooktop 10. For example, a controller 24 may be provided within the induction cooktop 10 assembly for controlling power to one or more of the coils 12 of the induction cooktop 10 to achieve one or more target temperatures for one or more cooking zones 26 of the induction cooktop 10. A glass layer 28, or insulating layer, may form a cooking surface 30 and provide space between the coils 12 in the induction cooktop 10 and the cooking surface 30. It is contemplated that, while shown in FIG. 1 as having a circular shape, one or more of the coils 12 may have another polygonal or arcuate shape, such as a square, rectangle, a triangle, or the like. It is also contemplated that irregular polygonal shapes or partial rectangular shapes (e.g., rectangles with arcuate corners) may be provided. Accordingly, the cooktop 10 may incorporate one or more differently shaped coils 12, as will be described further herein. Further, the spacing and/or pattern of distribution of the coils 12 for the induction cooktop 10 may be different than pictured or the same as pictured. For example, the coils 12 may be arranged side to side or front to back to provide a free-form induction cooking area 18 throughout the entire cooking surface 30 or a substantial part of the cooking surface 30. Further, different sizes of the coil may be provided.

The induction cooktop 10 is operable with different types of cookware 32. For example, pots and pans having different shapes, material compositions, sizes, etc. can be heated via induction heating from the coils 12. Depending on the type of the cookware 32 used, the electrical power drawn by the coil/applied to the cookware 32 differs. As will be described further herein, the control circuitry can detect power drawn by the coils 12 and, therefore, identify the type of cookware 32 used and/or the range of power levels attainable by the cookware 32 for a given frequency range.

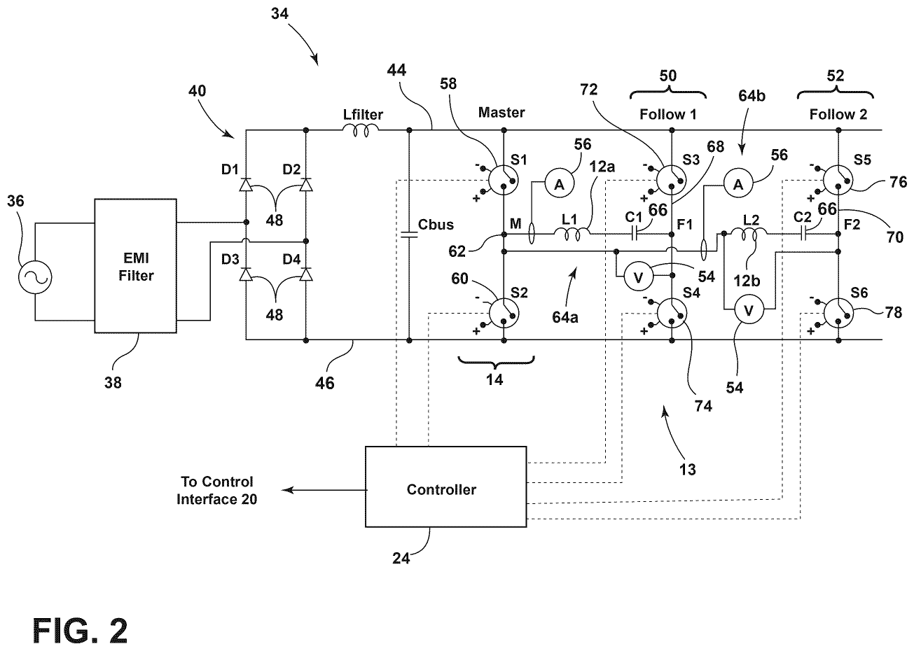

Referring now to FIG. 2, a heating circuit 34 is provided in reference to two exemplary coils 12 (i.e., a first coil 12a and a second coil 12b), though any number of coils 12 may be managed by the heating circuit 34. The heating circuit 34 may be powered via main power 36, which may be an alternating-current (AC) voltage. For example, the main power 36 may include 110 VAC, 115 VAC, 120 VAC, 230 VAC, 240 VAC, 480 VAC, or another AC signal typically provided for residential or commercial power distribution. The frequency of the main power 36 may be 50 Hz, 60 Hz. An electromagnetic interference (EMI) filter 38 is provided for reducing electromagnetic interference generated during high-frequency operation of the induction cooktop 10. This filter typically includes capacitors and inductors arranged to suppress unwanted electromagnetic radiation.

Filtered power is provided to a rectifier 40 that converts alternating current power to direct current (DC) power provided along a DC bus that includes a positive node 44 and a negative node 46. The rectifier 40 can include one or more diodes 48. One or more capacitors can be connected to the DC bus to smooth the DC voltage. Usually, a differential mode choke is connected between the rectifier 40 and the DC bus capacitors to form a filter together with the capacitors, to further filter and smooth the DC voltage.

The switching circuitry 13 is downstream of the rectifier 40 and is powered by the DC bus. For example, a plurality of inverters is electrically coupled with the DC bus. Each inverter can be a half-bridge inverter. As demonstrated, for two coils 12, the heating circuit 34 can include three half-bridge inverters 14, 50, 52. For example, there may be a first full-bridge inverter that includes a first half-bridge inverter 50 and a shared half-bridge inverter 14 that are arranged to control current through the first coil 12a. A second full-bridge inverter includes a second half-bridge inverter 52 and the shared half-bridge inverter 14 for controlling current through the second coil 12b. Stated differently, the shared half-bridge inverter 14 is common to the first full-bridge inverter and the second full-bridge inverter.

Although two coils 12 and two full-bridge inverters are shown in the present example, it is contemplated that the shared half-bridge inverter 14 may be common to any number of full-bridge inverters that power a specific coil. For example, if five coils 12 are provided for the induction cooktop 10, a total of six half-bridge inverters may be provided (e.g., one shared half-bridge inverter 14 and five individual half-bridge inverters corresponding to the individual coils 12). The shared half-bridge inverter 14 may be referred to as a master inverter, or primary inverter 14, and the first and second half-bridge inverters 50, 52 may be referred to as slave inverters, or secondary inverters 50, 52.

With continued reference to FIG. 2, the control circuitry is provided for controlling the half-bridge inverters 14, 50, 52. For example, the controller 24 can control each half-bridge inverter 14, 50, 52. The controller 24 can include a processor and a memory. The memory stores instructions that, when executed by the processor, cause the controller 24 to perform various steps related to electrical activation and electrical sensing. For example, the controller 24 can be in communication with the control interface 20 for detecting one or more target power levels (e.g., temperatures, setpoints, heating levels,) for the cooking zones 26 of the induction cooktop 10 and, in response, the controller 24 can communicate activation signals to the switching circuitry 13 to cause the coil(s) to induce eddy currents in the cookware 32, thereby achieving the one or more power levels. The controller 24 may also monitor feedback from the switching circuitry 13, such as voltages applied to or currents flowing through the coils 12. For example, the control circuitry may monitor a voltage across and a current through each coil via a voltage sensor 54 (e.g., a voltage divider) and a current sensor 56 (e.g., an ammeter), respectively. Other current sensing or voltage sensing devices may be employed. Further, feedback voltages or currents measured at other nodes of the heating circuit 34 may be monitored by the control circuitry.

The control circuitry can control the switching circuitry 13 via communicating activation signals to the half-bridge inverters. For example, the shared half-bridge inverter 14 can include a first switch 58 in series with a second switch 60 via a shared intermediate node 62. The first switch 58 interposes the positive node 44 of the DC bus and the shared intermediate node 62. The second switch 60 interposes the negative node 46 of the DC bus and the shared intermediate node 62. Each coil 12a, 12b is electrically coupled with the shared intermediate node 62 and is part of a resonant circuit 64 having an inductance and an effective resistance. For example, the first coil 12a can be part of a first resonant circuit 64a, and the second coil 12b can be part of a second resonant circuit 64b.

The load is a series resonant circuit 64 composed of an inductor and a capacitor. The value of the resistance is the electrical resistance value offered by the coil 12a, 12b together with the cookware 32 above it at a given working frequency. The resistance therefore depends on the given coil, the cookware 32, and the distance between them. Moreover, due to the skin effect, the resistance also depends on the frequency. Being a resonant network, the total impedance depends on the operating frequency. In particular, there will be a resonance frequency where the impedance will be resistive (condition in which the power transferred to the cookware 32 is maximum). As the working frequency varies, the impedance can be more inductive (frequencies greater than the resonance frequency) or more capacitive (frequencies lower than the resonance frequency). Series resonant converters, half-bridge, or full-bridge, can be able to operate in a soft switching condition for the power devices if operated at frequencies above the resonant frequency, therefore in the inductive zone. Maintaining operation in this range provides for soft switching operation in which devices experience conduction-related dissipation exclusively. To achieve the maximum power delivery to the cookware 32, the switching circuitry 13 operates at frequencies near resonance, whereas operating at higher frequencies provides a lower power delivery.

With continued reference to FIG. 2, each resonant circuit 64a, 64b includes a resonant capacitor 66 that is in series with the given coil 12a, 12b and is electrically coupled with a target intermediate node 68, 70. In some examples, the resonant capacitor 66 may be electrically coupled with the coil 12a 12b in another way, such as interposing the coil 12a, 12b and the shared intermediate node 62. In some examples, multiple resonant capacitors 66 are provided for each coil 12a, 12b. For example, the first full-bridge inverter can include a first intermediate node 68 and the second full-bridge inverter can include a second intermediate node 70. The first half-bridge inverter 50 includes a third switch 72 that interposes the positive node 44 and the first intermediate node 68 and a fourth switch 74 that interposes the negative node 46 and the first intermediate node 68. Similarly, the second full-bridge inverter includes a fifth switch 76 that interposes the positive node 44 and the second intermediate node 70 and a sixth switch 78 that interposes the negative node 46 and the second intermediate node 70. The switches 58, 60, 72, 74, 76, 78 may include transistors or other switching devices. In some examples, the transistors are insulated-gate bipolar transistors (IGBTs).

In general, the switching circuitry 13 is controlled to produce alternating currents through the coils 12. By way of example, the first full-bridge inverter controls power to the first coil 12a by selectively activating the first switch 58, the second switch 60, the third switch 72, and the fourth switch 74 in a specific pattern. For example, the first switch 58 and the fourth switch 74 can be activated at the same time to cause current to flow through the load. The first switch 58 and the fourth switch 74 can then be deactivated, then the second switch 60 and the third switch 72 can be activated to cause current to flow through the load in an opposite direction than when the first switch 58 and the fourth switch 74 are activated.

With continued reference to FIG. 2, the controller 24 is configured to communicate activation signals to the switching circuitry 13 at a common switching frequency. Stated differently, each switch in use (e.g., each switch used to achieve the target power level of a cooking zone 26) can be activated or deactivated at the same frequency. However, the activation signals can be communicated at different times to limit noise. For example, each of the first-sixth switches 58, 60, 72, 74, 76, 78 can be activated at a frequency of 100 kilo-Hertz (kHz). This common frequency can be changed by the control circuitry, though the switching frequency will nonetheless remain the same for all of the switches. By maintaining the same switching frequency, electrical or audible noise typically generated by unequal switching frequencies can be limited. To independently control current through the first coil 12a relative to current through the second coil 12b while maintaining the common switching frequency, the control circuitry is configured to phase shift the activation signals to the switches and/or adjust the common switching frequency.

The present arrangement can provide greater flexibility of control relative to other arrangements. For example, single-ended quasi-resonant arrangements are very complex to control and, due to the high working voltages, can be subject to high rate of device failure/damage. Further, the controllability range of the power on the cookware 32 can be very narrow relative to the present arrangement, thereby forcing the inverter(s) to work in ON/OFF mode when low power levels are requested by the user or otherwise set as a target power level. For example, if a target power level is 100 Watts (W) and the minimum power achievable is 700 W, the system must operate in the ON/OFF mode, in which 700 W is supplied for a short time (ON phase) and for the remaining time the inverter is kept OFF to obtain an average power delivery of 100 W. During the OFF phase in which there is no power delivery, the DCBUS capacitors are charged at the peak of rectified mains line voltage. When the ON phase is again applied, an acoustic noise (e.g., a ticking noise) can be generated due to the discharge of the DCBUS capacitors at the peak rectified mains line voltage. Further, during the quick discharge of the DCBUS capacitors a large amount of power is dissipated (high hard-switching), thereby resulting in thermal inefficiencies that can cause stress on the system and cause undesired temperatures in or around the induction cooktop 10.

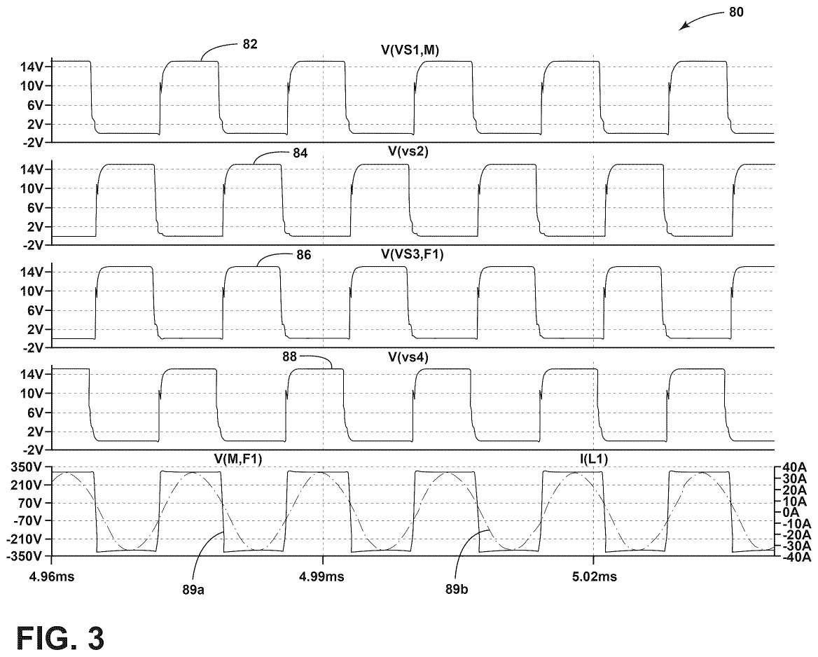

Referring now to FIG. 3, a first timing plot 80 demonstrates a 100% in-phase (no phase shift) operation of the first full-bridge inverter and the first resonant circuit 64a. In this example, a voltage having a square wave with a peak value of ±320 V is generated by the full-bridge inverter across the first resonant circuit 64a (between the shared intermediate node 62 and the first intermediate node 68), and the load model is formed with an inductance of 80 μH and a resistance of 10Ω. The resonant capacitor 66 has a capacitance of 66 nF. The controller 24 is configured to communicate pulse-width modulated (PWM) signals to the switches 58, 60, 72, 74, 76, 78. For example, the controller 24 can selectively communicate a first activation signal 82 to the first switch 58, a second activation signal 84 to the second switch 60, a third activation signal 86 to the third switch 72, and a fourth activation signal 88 to the fourth switch 74. In this example, the first full-bridge is operated 100% “in-phase” because the first activation signal 82 and the fourth activation signal 88 are activated for the same period, the second activation signal 84 and the third activation signal 86 are activated for the same period 180° offset from the first activation signal 82 and the second activation signal 84. As a result of the 100% in-phase operation, a fully alternating voltage 89a is applied across the first resonant circuit 64a. The fully alternating voltage produces a sinusoidal AC current 89b through the first resonant circuit 64a of 35 amperes peak.

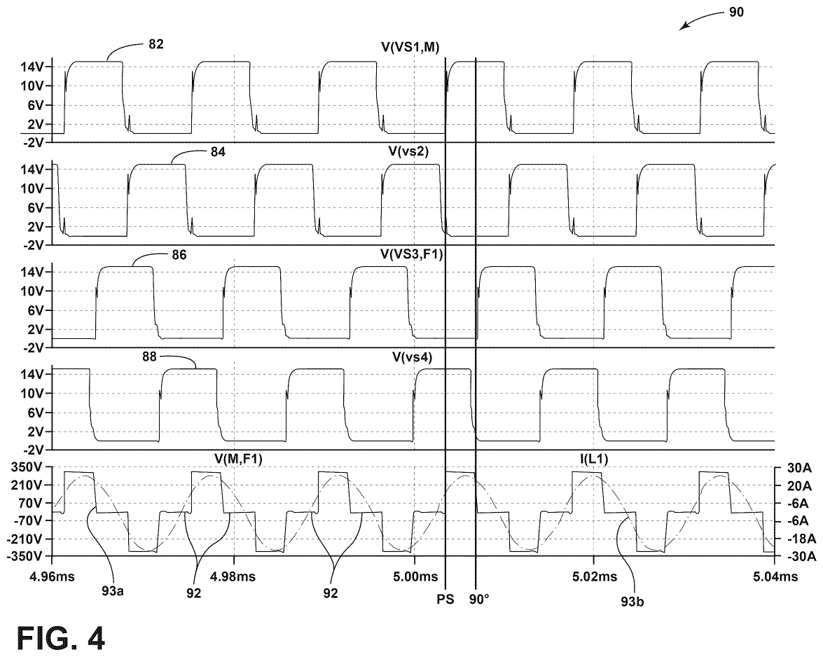

Referring now to FIG. 4, a second timing plot 90 demonstrates a 50% phase-shift operation of the first full-bridge and the first resonant circuit 64a. In this example, fourth activation signal 88 is initiated half-way through a period of activation of the first activation signal 82, and the third activation signal 86 is initiated half-way through an activation period of the second activation signal 84. Accordingly, the third activation signal 86 and the fourth activation signal 88 are phase shifted by 90° relative to the first activation signal 82 and the second activation signal 84, respectively. As a result of the 50% out-of-phase operation, a half-alternating voltage is applied across the first resonant circuit 64a. For example, because a positive voltage is applied when the first switch 58 and the fourth switch 74 are both activated, and a negative voltage is applied when the second switch 60 and the third switch 72 are both on, the resulting voltage has zeroed portions 92. The half-alternating voltage 93a produces a sinusoidal AC current 93b through the first resonant circuit 64a of 23 amperes peak.

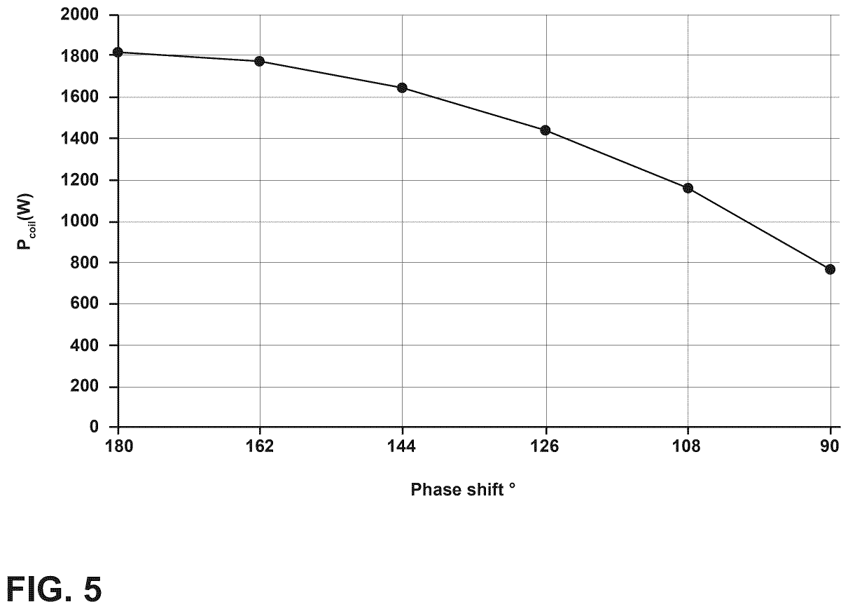

FIG. 5 demonstrates power on the resonant load vs. phase shift for a fixed switching frequency (81 kHz) of the switches 58, 60, 72, 74, 76, 78. The processes described further herein detail how phase-shifting and frequency determination can account for driving multiple coils 12 with the shared half-bridge inverter 14.

In the present disclosure, the common switching frequency remains consistent across each half-bridge inverter 14, 50, 52. The synchronization of the switching frequency limits intermodulation acoustic noises due to the magnetic coupling between the loads. However, single-frequency operation alone may not allow the system to deliver the different combinations of power requests when multiple coils 12 are activated simultaneously, particularly when the requested powers are widely different. Thus, the power for each secondary half-bridge inverter 50, 52 can be adjusted separately by the controller 24 determining an optimal combination of common switching frequency and phase shifts in order to deliver the desired power level as requested by the user or, in an automatic heat control mode, the system itself.

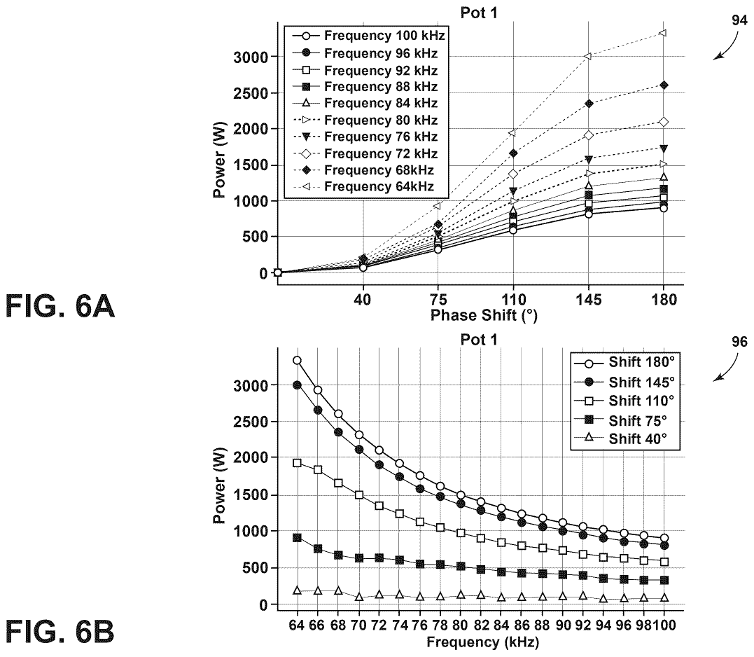

Referring now to FIGS. 6A-12, the algorithm performed by the control circuitry (e.g., the controller 24) will be demonstrated in view of relationships between power, switching frequency, and phase shift. To control the switching circuitry 13, the controller 24 can first map the cookware 32 used on the induction cooktop 10 to a mathematical function. Every pan exhibits unique characteristics, and when paired with specific coils 12, distinct power-to-frequency-and-phase-shift profiles may be generated. Such profiles can also be modified for a single pan that undergoes alterations in its properties as it heats up. The controller 24 is configured to identify these profiles in order to select the appropriate frequency and phase shifts for specific heating levels requested by the user or by the system.

The correlation between power, frequency, mains voltage, and phase shift depends on the coil and cookware 32 employed (e.g., the resonant circuit 64). The control circuitry is configured to perform a calibration to acquire a curve defining the relationship between frequency, phase shift, and delivered power for the corresponding coil. The calibration may be carried out in various scenarios (e.g., in response to placement of the cookware 32 on the coil, in response to the induction cooktop 10 being activated by the user, etc.). The information acquired during this calibration can be executed recursively during active operation and/or can be repeated in other scenarios as well, such as when the control circuitry detects that the actual delivered power differs significatively (e.g., by 2% or more, 5% or more, 10% or more, 20% or more) from the expected delivered power. The expected power is the power calculated based on the calculated curve.

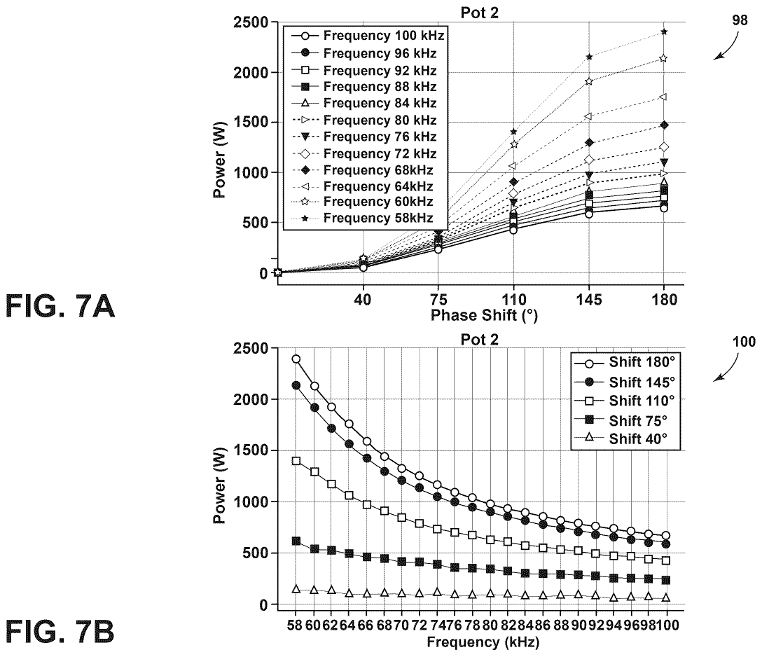

With particular reference FIGS. 6A-7B, plots 94, 96, 98, 100 of first cookware having first properties and second cookware having second properties are demonstrated. As illustrated in FIG. 6A, the relationship between power and phase shift for different common switching frequencies for the first resonant circuit 64a is attained at ten different frequencies. As illustrated in FIG. 6B, the relationship between power and frequency for different phase shifts for the first resonant circuit 64a is attained at five different phase shifts. The maximum power for the first resonant circuit 64a is 3300 W with no phase shift (180°) at the lowest tested frequency (64 kHz).

Similar to the plots of FIGS. 6A and 6B, the plots 98, 100 of FIGS. 7A and 7B illustrate the relationships between power, phase shift, and switching frequency for the second resonant circuit 64b. For the second resonant circuit 64b (e.g., the second cookware) the maximum power is limited to 2400 W with no phase shift (180°) at 58 kHz.

The estimation of the curves in FIGS. 6A-7B may take anywhere from 1 to 5 or more seconds for the controller 24 to calculate depending on the number of measurements taken by the control circuitry. Accordingly, the control circuitry is configured with an algorithm that provides an accurate approximation of these curves using one or more approximation functions that can minimize error between the power requested by the user for each cooking zone 26 and the power actually delivered to each cookware 32. The approximation process may be completed by the controller 24 in less than 0.5 seconds by applying at least one of the approximation functions to the information gathered from the calibration.

The correlation between power and phase shift at the different frequencies can be approximated via a generalized logistic function. Other approximation functions could be used. For example, a cubic polynomial, arctan, regularized incomplete beta, piecewise polynomial, or another approximation function may be applied to the data gathered from the calibration to generate the approximation curve. In the present example generalized logistic function may serve as an extension of the logistic or sigmoid functions, sometimes referred to as Richard's curve, having the following expression:

$$P ( f , φ ) = [ A + \frac{K - A}{{( C + {Qe}^{- B ( φ - M )} )}^{1 / v}} ] P ( f , 180 ° )$$

where P represents power at a given frequency f and phase shift φ. P(f, 180°) corresponds to the power measured at the same frequency f, but without any phase shift present.

The function has seven parameters:
A: the lower (left) asymptote;
K: the upper (right) asymptote when C=1. If A=0 and C=1, then K is carrying capacity;
B: the growth rate;
v>0: affects near which asymptote maximum growth occurs;
Q: is related to value P(f,0°);
C: constant, typically equal to 1; and
M: corresponds to starting time.

To minimize the root mean squared error (RMSE) across any applicable cookware 32 or resonant circuit 64 and a produce a computationally optimized model with limited computational time (e.g. 0.5 seconds) while maintaining accuracy, the values applied to the generalized logistic function are selected in order to minimize the aggregated error across multiple coils and cookware. The resulting simplified approximation functions may be stored in the controller 24 for determining optimal frequency and phase shift:

$$P ( f , φ ) = \frac{P ( f , 180 ° )}{1 + {e}^{- B ( φ - M )}}$$

$$φ ( f , P ) = - \frac{1}{B} ln [ \frac{P ( f , 180 ° )}{P} - 1 ] + M$$

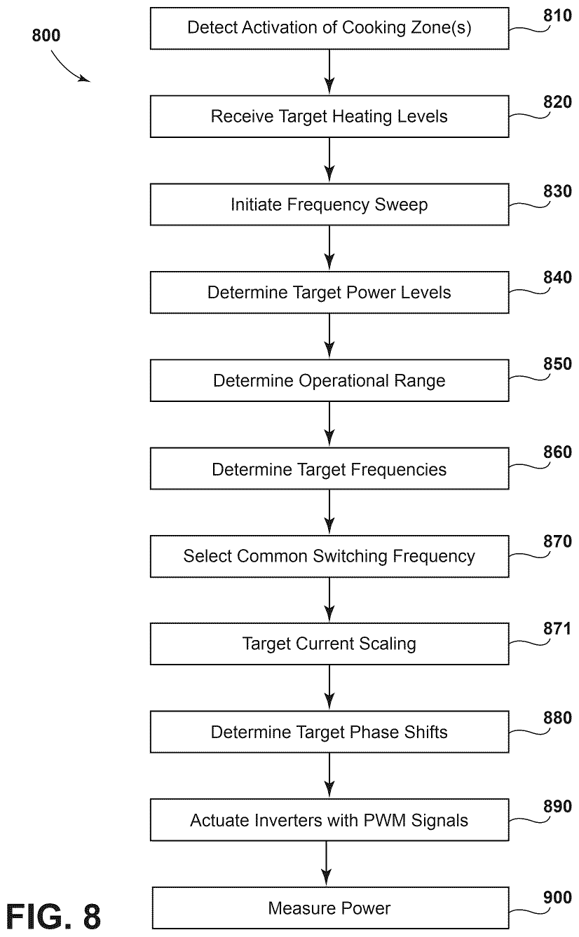

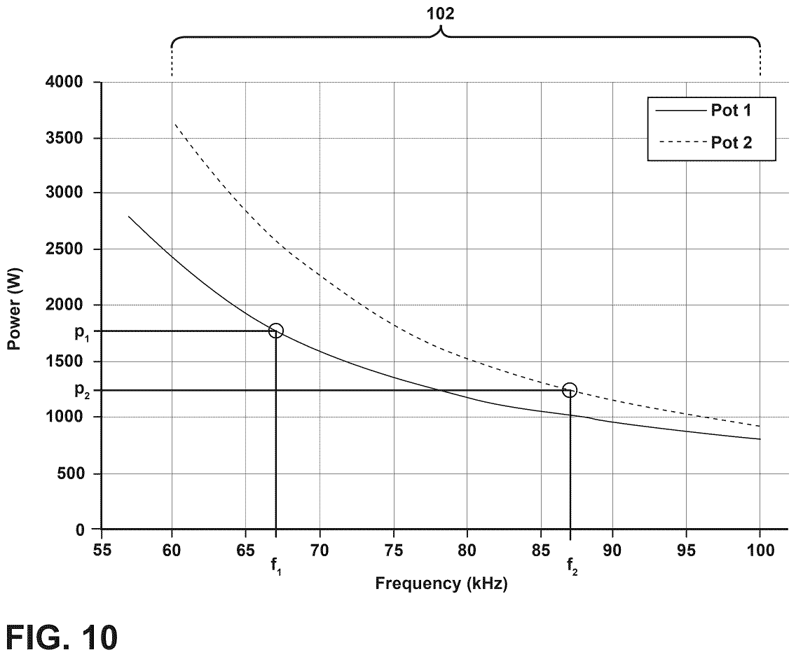

A method 800 for controlling the switching circuitry 13 of the heating circuit 34 for the induction cooktop 10 using phase shift and switching frequency will now be described in reference to FIG. 8 as applied to the example of FIG. 10. As such, the method 800 is described with respect to two resonant circuits 64 (the first and second resonant circuits 64a, 64b), two coils 12 (the first and second coils 12a, 12b), and two different articles of cookware 32. Referring more particularly to FIG. 8, at step 810, the control circuitry detects activation of one or more of the cooking zones 26. For example, the control circuitry may detect one or more electrical signals in response to adjusting a position of one or more of the knobs 22 (FIG. 1). At step 820, the control circuitry receives a plurality of target heating levels (via, e.g., the control interface 20) corresponding to a plurality of power levels for the coils 12. For example, the one or more electric signals may include analog voltages representative of a target heating level (e.g., 1-10, low-medium-high, etc.).

As a preliminary step (step 830), the controller 24 initiates a frequency sweep with no phase shift to identify the relationship between the power and the frequency (other frequency, or phase shift, sweeps could be performed to identify in a more complete way the relationship between Power, frequency and phase shift). For example, the control system can perform the mapping and/or calibration routines previously described (e.g., determining distinct power-to-frequency-and-phase-shift profiles for the cookware 32) to acquire the curve defining the operable relationships for induction cooking for a given coil/cookware combination.

At step 840, the target power level for the resonant circuits 64a, 64b are determined based on the data from the frequency sweep.

At step 850, the operable switching range 102 is determined. For example, the controller 24 can determine the highest target power level and the lowest power level for each resonant circuit 64a, 64b via magnitude comparison. In some examples, the controller 24 can determine the distinct pairs of minimum and maximum frequencies for each cookware 32 in use. This step may be recursively performed (e.g., every 0.1-60 seconds, every cycle of the mains frequency, etc.). The range 102 of operable switching frequencies refers to the range of switching frequencies operable between the induction cooktop 10 and both (or all) cookware 32 used simultaneously. For example, very high frequencies or very low frequencies may not induce power in the target cookware 32, depending on the material of the cookware 32. Referring briefly to FIG. 10, the operational switching frequencies for the first and second resonant circuits 64a, 64b having the first and second cookware, respectively, span from 60 kHz to 100 kHz.

At step 860, the target frequency for each resonant circuit 64a,64b is determined. For example, the controller 24 can determine the target frequency via the set of equations previously described using the target power levels and power-phase curves. For example, controller 24 determines the operable switching frequencies corresponding to the target power levels for the first and second (or all) simultaneously active resonant circuits 64a, 64b (see FIG. 10).

At step 870, the common switching frequency is determined by the control circuitry as described herein. For example, the lowest of the target frequencies can be selected.

By way of example, if the operable switching frequencies are within the operable switching range 102, the controller 24 compares the operable switching frequencies to one another and assigns the lower switching frequency to the common switching frequency. For example, because the lower frequency typically produces the higher power level, both the first cookware and the second cookware can be operable with the lower frequency, and the cookware 32 having the lower power level (e.g., higher frequency), can be phase shifted to attain the lower power level. Referring more particularly to the example of FIG. 10, the lower frequency f₁ (67 kHz) is assigned as the common switching frequency due to being less than all other target frequencies determined for the target power levels.

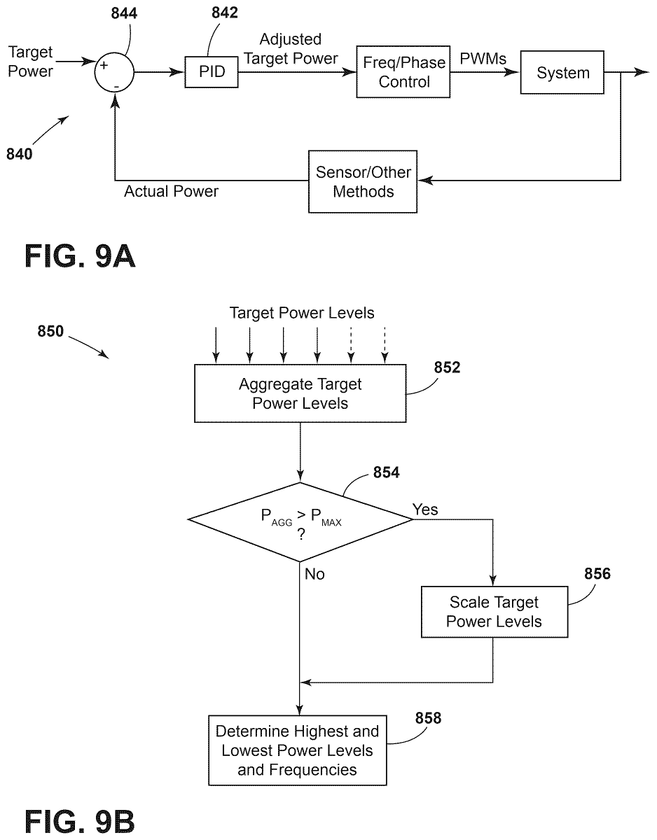

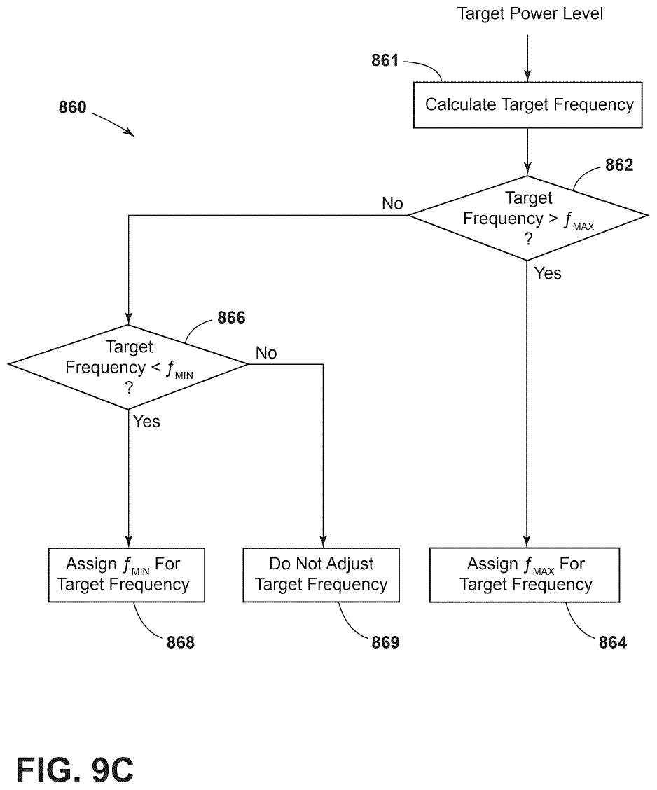

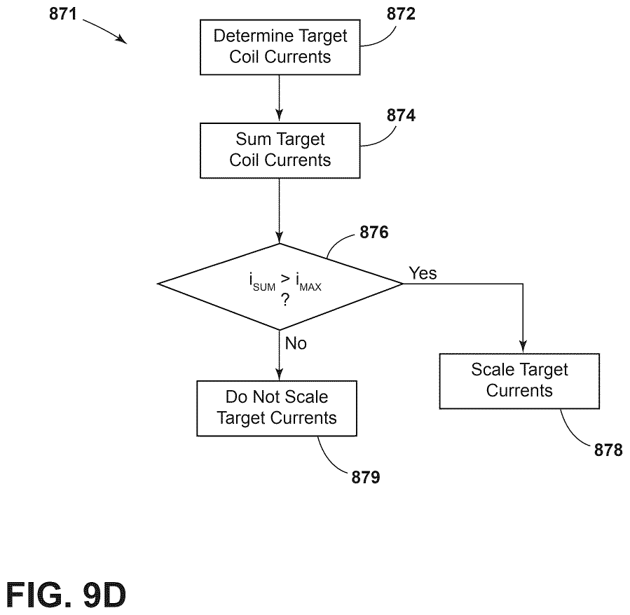

Current scaling occurs at step 871, the details of which are described in reference to FIG. 9D. For example, the calculated currents associated with given power/frequencies can be adjusted proportionally if a sum of calculated currents exceed a current threshold for the system.

At step 880, the target phase shift for each control signal is determined. For example, the controller 24 can determine the phase shift via calculation using the set of equations previously described using the identified relational curves.

At step 890, the inverters 50, 52 for each resonant circuit 64a, 64b are actuated according to a PWM schedule that produces the target frequencies.

At step 900, the power is measured. For example, the controller 24 can receive a signal indicative of current or currents drawn by the inverters 50, 52 or the entire system. Accordingly, the power monitoring may be specific to each resonant circuit 64a, 64b, thereby allowing the system to tune subsequent responses. The controller 24 may also receive a voltage signal (via, e.g., the voltage sensors 54). The controller 24 can calculate power draw using the current and the voltage. The detection of current, voltage, and/or power may be performed by any sensor or other arrangement. The monitored power is used as feedback into the determination of the target power levels at step 840. The current is used as feedback for current scaling at step 871, the details of which are described in reference to FIG. 9D.

Referring now to FIGS. 9A-9C, details of steps 840, 850, and 860, and 871, respectively, performed by method 800 are presented. With regard to step 840, and referring to FIG. 9A, the step of determining the target power level for each resonant circuit 64a, 64b can include power error correction that utilizes feedback of power actually drawn by a given resonant circuit 64a, 64b to compare to the target power level previously applied. For example, a PID control 842 utilizing at least one of a proportional gain, an integral gain, and a derivative gain, can be employed to tune subsequent target power commands. The output of the PID control 842 is output for frequency and phase control, thereby producing PWM signals to the switching circuitry 13 (i.e., “system” in FIG. 9A). The resulting actual power (as detected by, for example, a combination of the current sensor 56 and voltage sensor 54 for a given resonant circuit 64a, 64b) is fed back into an error control 844 that calculates a difference between target power and actual power to determine error. The error signal is provided to the PID control 842 to control the subsequent target power levels. In some examples, the PID control 842 includes only integral terms. In some example, the feedback (the actual power) and the previous target power level are each processed in a transfer function to provide an integral of each signal prior to feeding into error control 844. In general, the power error correction provides for adjusting the target power levels based on actual feedback.

The feedback check algorithm 840 of FIG. 9A can be implemented by calculating, at each half-wave, the cumulative sum of the delivered power level over the half-waves elapsed since the start of the power delivery, and comparing this value to the corresponding cumulative sum of the target power level over the same time period. The result of the comparison may constitute an average error that can be corrected in the next half-wave. The algorithm 840 can thus act as a purely integrative controller. However, other control methods can incorporate alternative control algorithms, such as PI regulators, PID regulators, optimal control regulators, and the like.

Referring now to FIG. 9B, step 850 of determining the operational range includes aggregating the target power level for each resonant circuit 64a, 64b in use at step 852. For example, the controller 24 can calculate a sum of the target power levels (P_{AGG}). At step 854, the aggregate target power P_{AGG} is compared to a maximum power P_{MAX} for the system. For example, the controller 24 can compare an estimated wattage to a threshold wattage that is a limit of the cooking hob/cooktop 10. If the aggregate target power P_{AGG} is greater than the maximum power P_{MAX}, the target power levels are scaled at step 856. For example, the controller 24 can reduce, according to a proportion of the target power levels, the aggregate target power P_{AGG} to be at or below maximum power P_{MAX} or another power threshold. In this way, the target power levels can be reduced according to relative proportions of the target power levels. If the target power P_{AGG} is less than or equal to the maximum power P_{MAX} or the target power levels have been scaled, the highest and lowest power levels are determined at step 858 to determine the operable range of the target power levels. At the same time, the corresponding highest and lowest frequencies are identified to determine the operable range of the target frequencies.

By way of example, the heating circuit 34 can have a maximum power P_{MAX} of 4 KW. If the controller 24 determines three target power levels 1.5 kW, 1.2 kW, and 2 kW for three resonant circuits, (totaling 4.7 kW), the controller 24 can scale the target power levels proportionally (e.g., 32%, 25%, and 43%, respectively), resulting in target power levels of 1.3 kW, 1 KW, and 1.7 kW, respectively. The controller 24 can then determine the operating range of (e.g., highest and lowest) target power levels to be between 1.7 kW and 1.0 kW at step 858. Also at step 858, the highest and lowest frequencies can be determined.

Referring now to FIG. 9C, determining the target frequencies at step 860 can include a target frequency error correction. At step 861, the control circuitry can calculate the target frequency for each resonant circuit 64a, 64b at step 861. For example, using the proxy frequencies from step 858, the controller can calculate target frequencies for each resonant circuit 64a, 64b. The target frequency for each resonant circuit 64a, 64b is compared to a maximum frequency f max at step 862. For example, the operating frequency range 102 for the heating circuit 34 can be between a minimum frequency f min and the maximum frequency f max (e.g., between 57 kHz and 100 kHz). If the target frequency is greater than the maximum frequency f max, the controller 24 can assign the target frequency to the maximum frequency f max at step 864. If the target frequency is less than the maximum frequency f max, the target frequency is compared to the minimum frequency f min at step 866. If the target frequency is less than the minimum frequency f min, the target frequency is assigned to the minimum frequency f min at step 868. If not, the target frequency is not adjusted at step 869, as the target frequency is within the operable frequency range 102.

Referring now to FIG. 9D, step 871 of scaling currents includes determining coil currents corresponding to the target phase shifts at step 872. For example, the controller 24 can calculate a current that may be drawn when the heating circuit 34 is operated according to the control signals at the given phase shifts. For example, the phase shift for each secondary half-bridge inverter 50, 52 utilized can be determined using simplified approximation functions. At step 874, the target coil currents are aggregated as an aggregate current i_{SUM}. The aggregate current i_{SUM} is compared to a maximum current i_{MAX} that the heating circuit 34 can supply at step 876. If the aggregate current i_{SUM} is less than the maximum current i_{MAX}, the method 800 proceeds to step 879 in which the target currents are not scaled. If not, the controller 24 scales the target currents at step 878 according to relative proportion among the plurality of the target currents. In this way, the target phase shifts can be scaled to reduce the current drawn by each resonant circuit 64a, 64b.

In operation, when one of the operable switching frequencies is inside the operable switching range 102, and another is higher than the maximum operable switching frequency (100 kHz) (e.g., when the power target level for the other resonant circuit is below the minimum attainable power level (for example 500 W)), the common switching frequency may be set at the one inside the operable range. The phase shift for the resonant circuit whose frequency falls inside the operable range may be set at 180°, and the phase shift for the other resonant circuit may be calculated using an approximating function.

In operation, when one of the operable switching frequencies is lower than the minimum of the operable switching range 102, and another is higher than the maximum operable switching frequency (100 kHz) (e.g., when the power target level for the other resonant circuit is below the minimum attainable power level (for example 500 W)), the common switching frequency may be set to the minimum of the operable switching range 102. The phase shift for the resonant circuit whose frequency falls below the minimum of the operable switching range 102 may be set at 180°, and the phase shift for the other resonant circuit may be calculated using an approximating function.

If at least one of the operable switching frequency is lower than the operable switching range 102 (e.g., a target power level of 2500 W for first resonant circuit 64a and target power level of 2000 W for second resonant circuit 64b in FIG. 10, or a target power level higher of 4000 W for the first resonant circuit 64a and a target power level of 500 W for second resonant circuit 64b in FIG. 9), the controller 24 assigns the minimum frequency in the operable range 102 to the common switching frequency at step 870.

With continued reference to FIG. 9D, the phase shift for each secondary half-bridge inverter 50, 52 is determined using the simplified approximation functions. In the present example, because the target power level relative to the first half-bridge inverter 50 is higher than the power levels attainable at the minimum frequency of the operable switching range 102, the phase shift for the activation signals to the first half-bridge inverter 50 is 180° (i.e., no phase shift) relative to the activation signals for the shared half-bridge inverter 14, and the phase shift for the second half-bridge inverter 52 is about 145°. Moreover, in the example in which the target power level relative to the first half-bridge inverter 50 is higher than the power levels attainable at the minimum frequency of the operable switching range 102, the phase shift for the first half-bridge inverter 50 is 180° and the secondary half-bridge inverters 52 is phase shifted to attain the target power that is not on the power-frequency curves. For example, the phase shift of the activation signal for the second half-bridge inverter 50 is 56° relative to the activation signal timing for the shared half-bridge inverter 14.

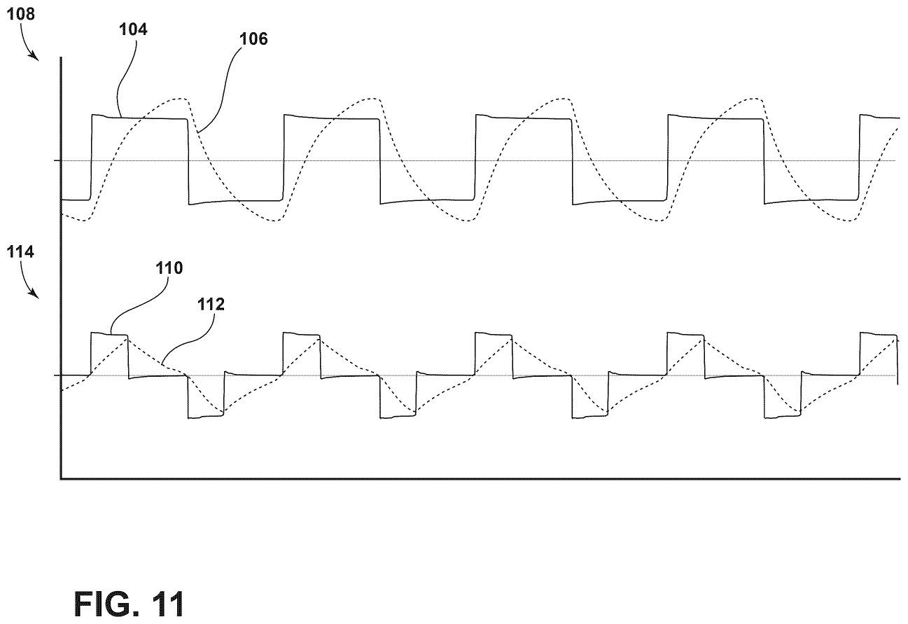

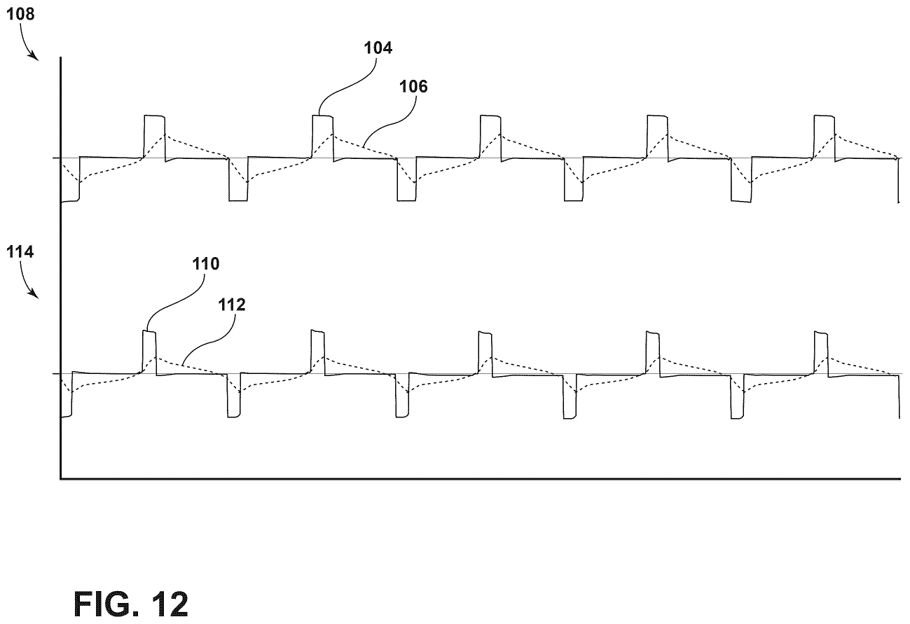

Referring now to FIGS. 11 and 12, two working examples of power delivery using the control algorithm described are depicted. With reference to FIG. 11, the input requests are p₁=1600 W and p₂=500 W. In this case, the power request for the first coil 12a is much higher than for the second coil 12b. Accordingly, the controller 24 operates the first half-bridge inverter 50 at 180° (i.e. no phase shift), while the controller 24 operates the second half-bridge inverter 52 at reduced value of phase shift. A first coil voltage 104 and a first coil 12a current 106 are demonstrated in a first plot 108, and a second coil voltage 110 and a second coil current 112 are demonstrated in a second plot 114.

With particular reference to FIG. 12 the input requests are p₁=200 W and p₂=100 W, both considered very low, and unreachable even with the maximum frequency of the inverter f max=100 kHz. In this case, the controller 24 operates both secondary half-bridge inverters 50, 52 with reduced values of phase shift. The first coil voltage 104 and the first coil 12a current 106 are demonstrated in the first plot 108, and the second coil voltage 110 and the second coil current 112 are demonstrated in the second plot 114.

According to one aspect of the present disclosure, an induction cooktop includes a first coil, a second coil, switching circuitry including a first full-bridge inverter that drives the first coil, a second full-bridge inverter that drives the second coil, and a shared half-bridge inverter common to the first full-bridge inverter and the second full-bridge inverter, and control circuitry configured to operate the switching circuitry at a common switching frequency to generate different power levels among the first coil and the second coil.

According to another aspect of the present disclosure, each full-bridge inverter includes a secondary half-bridge inverter that forms a full-bridge inverter with the shared half-bridge inverter.

According to another aspect of the present disclosure, each of the half-bridge inverters includes a pair of switches operated at the common switching frequency.

According to another aspect of the present disclosure, the control circuitry is configured to adjust a phase of activation signals to the switches at the common switching frequency by a phase shift to generate the different power levels.

According to another aspect of the present disclosure, the control circuitry is configured to adjust the common switching frequency to generate the different power levels.

According to another aspect of the present disclosure, the control circuitry is configured to determine the common switching frequency by determining a minimum working frequency corresponding to a higher power level among the different power levels and assigning the common switching frequency to the minimum working frequency.

According to another aspect of the present disclosure, the control circuitry is configured to determine the phase shift in response to determination of the common switching frequency.

According to another aspect of the present disclosure, the control circuitry is configured to communicate at least one test signal to the first full-bridge inverter and the second full-bridge inverter at the common switching frequency, detect power drawn by the first coil and the second coil in response to the at least one test signal, classify the first coil with a first operating frequency range and the second coil with a second operating frequency range.

According to another aspect of the present disclosure, the control circuitry is configured to approximate a power to phase-shift relationship for each operating frequency range.

According to another aspect of the present disclosure, the control circuitry is configured to approximate the power to phase-shift relationship for each operating frequency range with a generalized logistic function.

According to another aspect of the present disclosure, the control circuitry is configured to calculate an error between target power levels and sensed power delivered via the switching circuitry and adjust the target power levels based on the error.

According to another aspect of the present disclosure, the control circuitry is configured to compare a total of the different power levels to a power threshold of the induction cooktop and, in response the total exceeding the power threshold, adjust the different power levels proportionally to power levels having an aggregate not greater than the power threshold.

According to another aspect, a heating circuit includes a first coil, a second coil, switching circuitry including a first full-bridge inverter that drives the first coil, a second full-bridge inverter that drives the second coil, and a shared half-bridge inverter common to the first full-bridge inverter and the second full-bridge inverter, and control circuitry configured to operate the switching circuitry at a common switching frequency, and adjust a phase of activation signals to the switching circuitry at the common switching frequency by a phase shift to generate different power levels among the first coil and the second coil.

According to another aspect of the present disclosure, each full-bridge inverter includes a secondary half-bridge inverter that forms a full-bridge inverter with the shared half-bridge inverter.

According to another aspect of the present disclosure, each of the half-bridge inverters includes a pair of switches operated at the common switching frequency.

According to another aspect of the present disclosure, the control circuitry is configured to adjust the common switching frequency to generate the different power levels.

According to another aspect of the present disclosure, the control circuitry is configured to determine the common switching frequency by determining a minimum working frequency corresponding to a higher power level among the different power levels and assigning the common switching frequency to the minimum working frequency.

According to another aspect of the present disclosure, the control circuitry is configured to determine the phase shift in response to determination of the common switching frequency.

According to another aspect of the present disclosure, the control circuitry is configured [00106] to communicate at least one test signal to the first full-bridge inverter and the second full-bridge inverter at the common switching frequency, detect power drawn by the first coil and the second coil in response to the at least one test signal, and classify the first coil with a first operating frequency range and the second coil with a second operating frequency range.

According to another aspect of the present disclosure, the control circuitry is configured to approximate a power to phase-shift relationship for each operating frequency range.

According to yet another aspect, an induction cooktop includes a first coil, a second coil, switching circuitry including a first full-bridge inverter that drives the first coil, a second full-bridge inverter that drives the second coil, and a shared half-bridge inverter common to the first full-bridge inverter and the second full-bridge inverter, wherein each full-bridge inverter includes a secondary half-bridge inverter that forms a full-bridge inverter with the shared half-bridge inverter, and wherein each of the half-bridge inverters includes a pair of switches operated at the common switching frequency, and control circuitry configured to operate the switching circuitry at a common switching frequency, and adjust a phase of activation signals to the switches at the common switching frequency by a phase shift to generate a first power level for the first coil and a second power level different than the first power level for the second coil.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. An induction cooktop, comprising:
a first coil;
a second coil;
switching circuitry including a first full-bridge inverter that drives the first coil, a second full-bridge inverter that drives the second coil, and a shared half-bridge inverter common to the first full-bridge inverter and the second full-bridge inverter; and
control circuitry configured to operate the switching circuitry at a common switching frequency to generate different power levels among the first coil and the second coil.

2. The induction cooktop of claim 1, wherein each full-bridge inverter includes a secondary half-bridge inverter that forms a full-bridge inverter with the shared half-bridge inverter.

3. The induction cooktop of claim 2, wherein each of the secondary half-bridge inverters includes a pair of switches operated at the common switching frequency.

4. The induction cooktop of claim 3, wherein the control circuitry is configured to adjust a phase of activation signals to the switches at the common switching frequency by a phase shift to generate the different power levels.

5. The induction cooktop of claim 4, wherein the control circuitry is configured to adjust the common switching frequency to generate the different power levels.

6. The induction cooktop of claim 5, wherein the control circuitry is configured to determine the common switching frequency by determining a minimum working frequency corresponding to a higher power level among the different power levels and assigning the common switching frequency to the minimum working frequency.

7. The induction cooktop of claim 6, wherein the control circuitry is configured to determine the phase shift in response to determination of the common switching frequency.

8. The induction cooktop of claim 7, wherein the control circuitry is configured to:
communicate at least one test signal to the first full-bridge inverter and the second full-bridge inverter at the common switching frequency;
detect power drawn by the first coil and the second coil in response to the at least one test signal; and
classify the first coil with a first operating frequency range and the second coil with a second operating frequency range.

9. The induction cooktop of claim 8, wherein the control circuitry is configured to approximate a power to phase-shift relationship for each operating frequency range.

10. The induction cooktop of claim 9, wherein the control circuitry is configured to approximate the power to phase-shift relationship for each operating frequency range with a generalized logistic function.

11. The induction cooktop of claim 6, wherein the control circuitry is configured to calculate an error between target power levels and sensed power delivered via the switching circuitry and adjust the target power levels based on the error.

12. The induction cooktop of claim 1, wherein the control circuitry is configured to compare a total of the different power levels to a power threshold of the induction cooktop and, in response the total exceeding the power threshold, adjust the different power levels proportionally to power levels having an aggregate not greater than the power threshold.

13. A heating circuit, comprising:
switching circuitry including a first full-bridge inverter that drives a first coil, a second full-bridge inverter that drives a second coil, and a shared half-bridge inverter common to the first full-bridge inverter and the second full-bridge inverter; and
control circuitry configured to:
operate the switching circuitry at a common switching frequency; and
adjust a phase of activation signals to the switching circuitry at the common switching frequency by a phase shift to generate different power levels among the first coil and the second coil.

14. The heating circuit of claim 13, wherein each full-bridge inverter includes a secondary half-bridge inverter that forms a full-bridge inverter with the shared half-bridge inverter.

15. The heating circuit of claim 14, wherein each of the secondary half-bridge inverters includes a pair of switches operated at the common switching frequency.

16. The heating circuit of claim 15, wherein the control circuitry is configured to adjust the common switching frequency to generate the different power levels.

17. The heating circuit of claim 16, wherein the control circuitry is configured to determine the common switching frequency by determining a minimum working frequency corresponding to a higher power level among the different power levels and assigning the common switching frequency to the minimum working frequency.

18. The heating circuit of claim 17, wherein the control circuitry is configured to determine the phase shift in response to determination of the common switching frequency.

19. The heating circuit of claim 18, wherein the control circuitry is configured to:
communicate at least one test signal to the first full-bridge inverter and the second full-bridge inverter at the common switching frequency;
detect power drawn by the first coil and the second coil in response to the at least one test signal; and
classify the first coil with a first operating frequency range and the second coil with a second operating frequency range.

20. An induction cooktop, comprising:
a first coil;
a second coil;
switching circuitry including a first full-bridge inverter that drives the first coil, a second full-bridge inverter that drives the second coil, and a shared half-bridge inverter common to the first full-bridge inverter and the second full-bridge inverter, wherein each full-bridge inverter includes a secondary half-bridge inverter that forms a full-bridge inverter with the shared half-bridge inverter, and wherein each of the secondary half-bridge inverters includes a pair of switches operated at the common switching frequency; and
control circuitry configured to:
operate the switching circuitry at a common switching frequency; and
adjust a phase of activation signals to the switches at the common switching frequency by a phase shift to generate a first power level for the first coil and a second power level different than the first power level for the second coil.
